(19) United States
(12) Patent Application Publication
(10) Pub. No.: US 2013/0233085 A1
(43) Pub. Date: Sep. 12, 2013

(54) DIFFERENTIAL PRESSURE SENSOR

(71) Applicant: AZBILL CORPORATION, Tokyo (JP)

(72) Inventors: Jun MIZOGUTI, Tokyo (JP); Tatsuo TANAKA, Tokyo (JP)

(73) Assignee: AZBIL CORPORATION, Tokyo (JP)

(21) Appl. No.: 13/786,551

(22) Filed: Mar. 6, 2013

(30) Foreign Application Priority Data
Mar. 6, 2012 (JP) 2012-049491

(51) Int. Cl. G01L 7/02

(52) U.S. Cl. CPC G01L 7/022
USPC 73/716

(57) ABSTRACT

A differential sensor includes a sensor chip having first and second stopper members provided to first and second faces of a sensor diaphragm, respectively, first and second duct members provided to first and second faces of the sensor chip, having, therein, pressure guiding ducts that guide measurement pressures to the first and second faces of the sensor diaphragm, respectively, and an elastic holding member that applies an elastic force to the first duct member in the direction of the first face of the sensor chip, applies an elastic force to the second duct member in the direction of the second face of the sensor chip, and holds the sensor chip under pressure between the first duct member and the second duct member.

### CROSS REFERENCE TO RELATED APPLICATION

This application claims priority to Japanese Patent Application No. 2012-049491, filed on Mar. 6, 2012, the entire content of which being hereby incorporated herein by reference.

### FIELD OF TECHNOLOGY

The present invention relates to a differential pressure sensor that uses a sensor diaphragm for detecting a signal in response to a pressure differential.

### BACKGROUND ART

Conventionally, commercial differential pressure transmitters have used a differential pressure transmitter that includes a differential pressure sensor that uses a sensor diaphragm that outputs a signal in response to a differential pressure. This differential pressure transmitter is configured so that the pressures that are applied to a high-pressure side and a low-pressure side of a pressure bearing diaphragm are transmitted to the respective sides of the sensor diaphragm through a sealed liquid, as a pressure transmitting medium, where strain on the sensor diaphragm is detected as, for example, a change in a resistance value of a strain resistance gauge, where this change in resistance value is converted into an electric signal that is read out.

Such differential pressure transmitters are used, for example, to measure the height of a fluid surface in, for example, a high temperature reaction tower in an oil refinery by detecting the differential pressure between two locations at different has in a closed tank that stores the fluid that is being measured.

FIG. 4 illustrates schematically a conventional differential pressure transmitter. The differential pressure transmitter 100 is structured with a sensor chip 1 having a sensor diaphragm (not shown) incorporated in a meter body 2. The sensor diaphragm in the sensor chip 1 is made from silicon, glass, or the like, and the strain resistance gauge is formed on the surface of the diaphragm, which is formed as a thin plate. The meter body 2 is made from a main unit portion 3, made out of metal, and a sensor portion 4, where barrier diaphragms (pressure-bearing diaphragms) 5a and 5b, which form a pair of pressure-bearing portions, are provided on the side faces of the main unit portion 3, and the sensor chip 1 is incorporated in the sensor portion 4.

In the meter body 2, between the sensor chip 1 that is incorporated into the sensor portion 4 and the barrier diaphragms 5a and 5b that are provided in the main unit portion 3, pressure transmitting mediums 9a and 9b, such as silicone oil, are sealed into connecting ducts 8a and 8b that connect the sensor chip 1 and the barrier diaphragms 5a and 5b through connecting, respectively, through pressure buffering chambers 7a and 7b that are separated by a large-diameter center diaphragm 6.

Note that the reason why the pressure medium, such as silicone oil, is necessary is because it is necessary to separate the sensor diaphragm, which has the sensitivity to the stress (pressure), from the pressure-bearing diaphragm, which is resistant to corrosion, in order to prevent foreign material within the measurement medium from adhering to the sensor diaphragm and to prevent corrosion of the sensor diaphragm.

In this differential pressure transmitter 100, a first measurement pressure Pa from a process is applied to the barrier diaphragm 5a and a second measurement pressure Pb, from the process, is applied to the barrier diaphragms 5b, as illustrated schematically for the proper operating state in FIG. 5(a). As a result, the barrier diaphragms 5a and 5b dislocate and the pressures Pa and Pb that are applied thereto are conveyed through the pressure transmitting mediums 9a and 9b through the pressure buffering chambers 7a and 7b that are separated by the center diaphragm 6, to the respective sides of the sensor diaphragm of the sensor chip 1. As a result, the sensor diaphragm of the sensor chip 1 undergoes dislocation corresponding to the differential pressure ΔP between these two transmitted pressures Pa and Pb.

In contrast, when, for example, an excessively large pressure Pover is applied to the barrier diaphragm 5a, the barrier diaphragm 5a undergoes a large dislocation, as illustrated in FIG. 5(b), and thus the center diaphragm 6 undergoes deformation so as to absorb the excessively large pressure Pover. Moreover, when the barrier diaphragm 5a tightly contacts the bottom face (an excessive pressure protecting face) of a recessed portion 10a of the meter body 2 so that that dislocation is constrained, this prevents the transmission of any differential pressure ΔP in excess of that to the sensor diaphragm through the barrier diaphragm 5a. Similarly, when an excessively large pressure Pover is applied to the barrier diaphragm 5b, then, in the same manner as when an excessively large pressure Pover was applied to the barrier diaphragm 5a, then when the barrier diaphragm 5b tightly contacts the bottom face (the excessive pressure protecting face) of the recessed portion 10b of the meter body 2 so that that dislocation is constrained, this prevents the transmission of any differential pressure ΔP in excess of that to the sensor diaphragm through the barrier diaphragm 5b. The result is that this prevents breakage of the sensor chip 1 by the application of the excessively large pressure Pover, that is, this prevents in advance breakage of the sensor diaphragm in the sensor chip 1.

In this differential pressure transmitter 100, the sensor chip 1 is enclosed within the meter body 2, thus making it possible to protect the sensor chip 1 from the external corrosive environment, such as the process fluids. However, because the recessed portions 10a and 10b are provided in order to constrain the dislocation of the center diaphragm 6 and the barrier diaphragms 5a and 5b, in a structure to protect the sensor chip 1 from the excessive pressure Pover thereby, the dimensions thereof are unavoidably larger.

Given this, a first stopper member and a second stopper member are provided in the sensor chip, where recessed portions of the first stopper member and the second stopper member face the respective surfaces of the sensor diaphragm to thereby prevent excessive dislocation of the sensor diaphragm when an excessively large pressure is applied, in a structure that has been proposed for preventing breakage/destruction of the sensor diaphragm thereby. See, for example, Japanese Unexamined Patent Application Publication 2005-69736 (“the JP '736”).

FIG. 6 illustrates schematically a sensor chip that uses the structure shown in the JP '736. In this figure, 11-1 is a sensor diaphragm, 11-2 and 11-3 are first and second stopper members that are bonded with the sensor diaphragm 11-1 interposed therebetween, and 11-4 and 11-5 are pedestals to which the stopper members 11-2 and 11-3 are bonded. The stopper members 11-2 and 11-3 and the pedestals 11-4 and 11-5 are formed from silicon, glass, or the like.

In the sensor chip 11, recessed portions 11-2a and 11-3a are formed in the stopper members 11-2 and 11-3, where the recessed portion 11-2a of the stopper member 11-2 faces one face of the sensor diaphragm 11-1, and the recessed portion 11-3a of the stopper member 11-3 faces the other face of the sensor diaphragm 11-1. The recessed portions 11-2a and 11-3a have curved surfaces (spherical surfaces), following the dislocation of the sensor diaphragm 11-1, and, at the apexes thereof, pressure guiding holes 11-2b and 11-3b are formed. In the pedestals 11-4 and 11-5 as well, pressure guiding holes 11-4a and 11-5a are formed at positions corresponding to the pressure guiding holes 11-2b and 11-3b of the stopper members 11-2 and 11-3.

When this type of sensor chip 11 is used, when an excessively large pressure is applied to one face of the sensor diaphragm 11-1, causing the sensor diaphragm 11-1 to undergo dislocation, the entirety of the dislocated face is supported and stopped by the curved surface of the recessed portion 11-3a of the stopper member 11-3. Moreover, if an excessively large pressure is applied to the other face of the sensor diaphragm 11-1, causing the sensor diaphragm 11-1 to undergo dislocation, the entirety of the dislocation face is supported and stopped by the curved surface of the recessed portion 11-2a of the stopper member 11-2.

As a result, when an excessively large pressure is applied to the sensor diaphragm 11-1 excessive dislocation is prevented, making it possible to increase the excessive pressure-protected operating pressure (durability) by effectively preventing accidental damage to the sensor diaphragm 11-1 through the application of an excessively large pressure, through making it so that there are no concentrated stresses at the peripheral edge portions of the sensor diaphragm 11-1. Moreover, in the structure illustrated in FIG. 4, it is possible to achieve miniaturization of the meter body 2 through eliminating the center diaphragm 6 and the pressure buffering chambers 7a and 7b and guiding the measurement pressures Pa and Pb directly from the barrier diaphragms 5a and 5b to the sensor diaphragm 11-1.

In the structure of such a sensor chip 11, the static pressure that acts on the interior thereof depends on the diameter of the sensor diaphragm 11-1. In order to increase the rangeability, it is necessary to increase the diameter of the sensor diaphragm 11-1 and to decrease the film thickness of the sensor diaphragm 11-1. However, satisfying such demands enlarges the pressure bearing surface internally, causing the application of pressures that are large enough to break the bonded portions within the sensor chip 11.

In the case of the sensor chip 11 that is illustrated in FIG. 6, there is a five-layer structure of the sensor diaphragm 11-1, the stopper members 11-2 and 11-3, and the pedestals 11-4 and 11-5. In this case, when there is a high pressure there is the risk that large pressure forces will act on the bonded portions in this five-layer structure, causing the bonded portions to delaminate. Moreover, when there is a change in the ambient temperature, thermal stresses caused by differences in coefficients of thermal expansion between the sensor chip 11 and the package 2 will also have an effect, which may cause the bonded portions within the sensor chip 11 to delaminate.

The present invention was created in order to solve such problems, and an aspect of the present invention is to provide a differential pressure sensor able to prevent delamination of the bonded portions within the sensor chip.

### SUMMARY

In order to achieve such an aspect, the differential pressure sensor according to the present invention includes a sensor chip that has a sensor diaphragm that outputs a signal in accordance with a differential pressure, a first stopper member that is bonded to the sensor diaphragm with a recessed portion of the first stopper member facing one face of the sensor diaphragm, and stops excessive dislocation when an excessively large pressure is applied to the other face of the sensor diaphragm, and a second stopper member that is bonded to the sensor diaphragm with a recessed portion of the second stopper member facing the other face of the sensor diaphragm, and stops excessive dislocation when an excessively large pressure is applied to the one face of the sensor diaphragm. The differential sensor also includes a first duct member, bonded to one face of the sensor chip, having, therein, a pressure guiding duct that guides a measurement pressure to the one face of the sensor diaphragm, a second duct member, bonded to the other face of the sensor chip, having, therein, a pressure guiding duct that guides a measurement pressure to the other face of the sensor diaphragm, and an elastic holding member that applies an elastic force to the first duct member in the direction of the one face of the sensor chip, applies an elastic force to the second duct member in the direction of the other face of the sensor chip, and holds the sensor chip under pressure between the first duct member and the second duct member.

In the present invention, the sensor chip is held under pressure, by an elastic holding member, between a first duct member and a second duct member. That is, an elastic force is applied to the first duct member by the elastic holding member in the direction of one face of the sensor chip, and an elastic force is applied to the second duct member in the direction of the other face of the sensor chip, to hold the sensor chip under pressure between the first duct member and the second duct member. This buffers the pressure forces and thermal stresses that act on the bonded portions of the sensor chip when there is a high-pressure or a change in the ambient temperature, preventing the bonded portions within the sensor chip from delaminating.

In the present invention, the elastic holding member is structured, for example, from an elastic first connecting duct that connects to the pressure guiding duct of the first duct member, and an elastic second connecting duct that connects to the pressure guiding duct of the second duct member, or may be leaf springs that are lain on the outsides of the first duct member and the second duct member. When the elastic holding member is structured from the elastic first connecting duct and second connecting duct, it can also act as a connecting duct that guides the measurement pressure to the sensor chip (a duct in which is sealed a pressure transmitting medium), thus making it possible to reduce part counts, reduce size, and reduce costs.

The present invention, includes a first duct member, bonded to one face of the sensor chip, having, therein, a pressure guiding duct that guides a measurement pressure to the one face of the sensor diaphragm and a second duct member, bonded to the other face of the sensor chip, having, therein, a pressure guiding duct that guides a measurement pressure to the other face of the sensor diaphragm, and the sensor chip is held under pressure by the elastic holding member between the first duct member and the second duct member, and thus the pressure forces and thermal stresses that act on the bonded portions within the sensor chip are buffered when there is a high pressure or a change in the ambient temperature, thus making it possible to prevent delamination of the bonded portions within the sensor chip.

### BRIEF DESCRIPTION OF THE DRAWINGS

FIG. 1 is a diagram illustrating the critical portions (the supporting structure for the sensor chip that is incorporated in the meter body) of an example of a differential pressure sensor according to the present invention.

FIG. 2 is a diagram illustrating an example wherein ring-shaped leaf springs are provided lying on the outside of the first duct member and the second duct member, which are sandwiched therebetween.

FIG. 3 is a diagram illustrating an example wherein a U-shaped leaf spring is provided lying on either side of the first duct member and the second duct member, which are sandwiched therein.

FIG. 4 is a diagram illustrating a schematic structure for a conventional differential pressure transmitter.

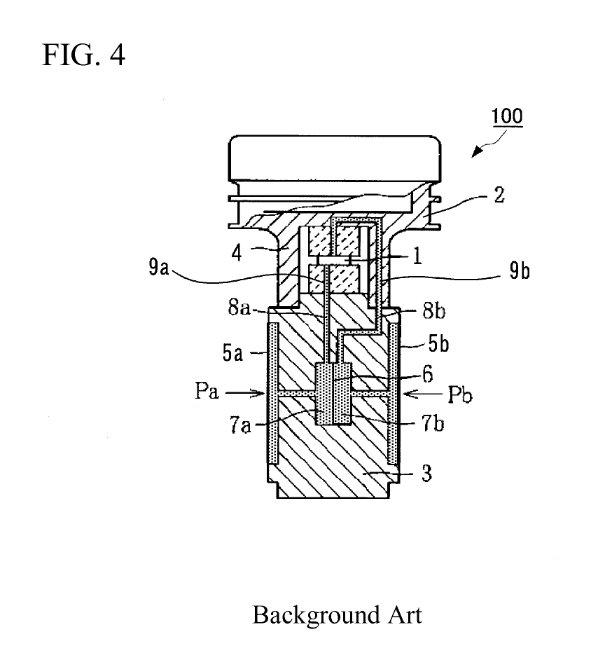

FIG. 5 is a diagram illustrating schematically the operating state of this differential pressure transmitter.

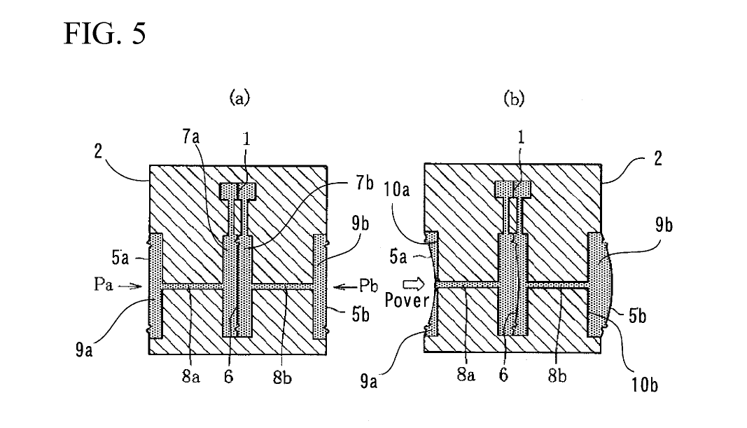

FIG. 6 is a diagram illustrating schematically a sensor chip that uses the structure illustrated in the JP '736.

### DETAILED DESCRIPTION

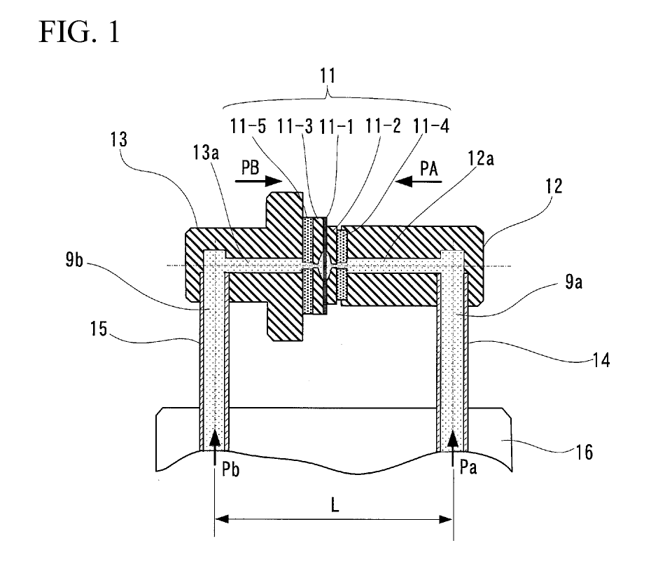

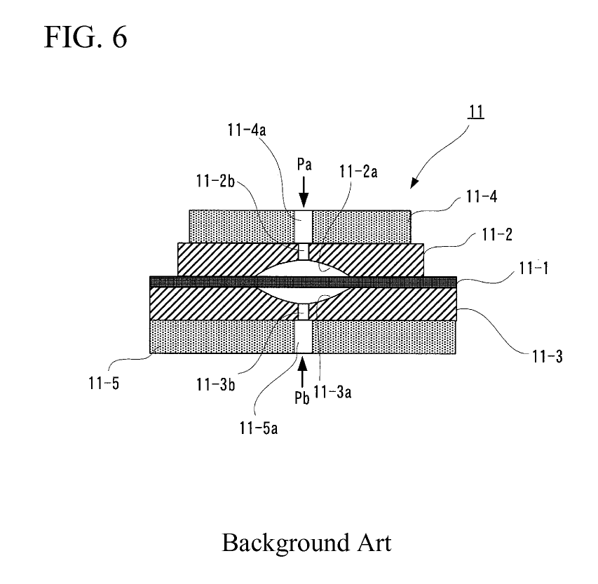

A form of example according to the present invention will be explained below in detail, based on the drawings. FIG. 1 is a diagram illustrating the critical portions in an example of a differential pressure sensor according to the present invention. In this figure, a supporting structure for the sensor chip 11 (FIG. 6) that is incorporated in a meter body is illustrated as the structure for the differential pressure sensor that is incorporated in the differential pressure transmitter.

In this supporting structure, a first duct member 12 is bonded to one face of the sensor chip 11, and a second duct member 13 is bonded to the other face of the sensor chip 11. The first duct member 12 has, therein, a pressure guiding duct 12a that guides the measurement pressure Pa to the one face of the sensor diaphragm 11-1 and the second duct member 13 has, therein, a pressure guiding duct 13a for guiding the measurement pressure Pb to the other face of the sensor diaphragm 11-1.

Moreover, in this supporting structure, elastic first connecting duct 14 and second connecting duct 15 protrude from the top face of a pedestal 16, separated by a specific distance L, where the first connecting duct 14 is connected to the pressure guiding duct 12a of the first duct member 12, and the second connecting duct 15 is connected to the pressure guiding duct 13a of the second duct member 13.

At this time, the elasticity of the connecting ducts 14 and 15 apply an elastic force PA onto the first duct member 12 in the direction of the one face of the sensor chip 11, and apply an elastic force PB to the second duct member 13 in the direction of the other face of the sensor chip 11, so as to hold the sensor chip 11 under pressure between the first duct member 12 and the second duct member 13.

That is, in the present form of example, the first connecting duct 14 is caused to have two functions, the function of a duct wherein the pressure transmitting medium 9a is sealed, and a function for producing an elastic force PA in the compressing direction, pressing on the sensor chip 11, and the second connecting duct 15 is caused to have two functions, the function of a duct wherein the pressure transmitting medium 9b is sealed, and a function for producing an elastic force PB in the compressing direction, pressing on the sensor chip 11. In this case, the first connecting duct 14 and the second connecting duct 15 function as the “elastic holding member” in the present invention. As a result, it is possible to prevent the delamination of the bonded portions within the sensor chip 11 through buffering the pressure forces and thermal stresses that act on the bonded portions within the sensor chip 11 when there is a high pressure or a change in the ambient temperature.

Note that in this supporting structure, the materials of the first duct member 12 and the second duct member 13 may be, for example, Kovar, and the materials for the first connecting duct 14 and the second connecting duct 15 may be, for example, SUS316.

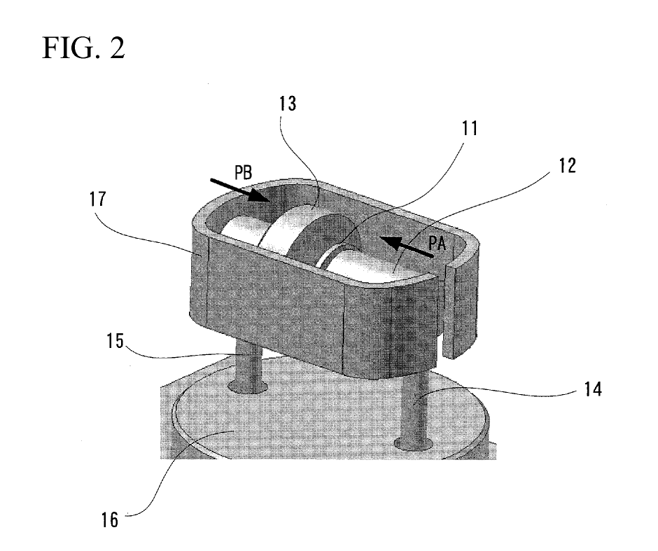

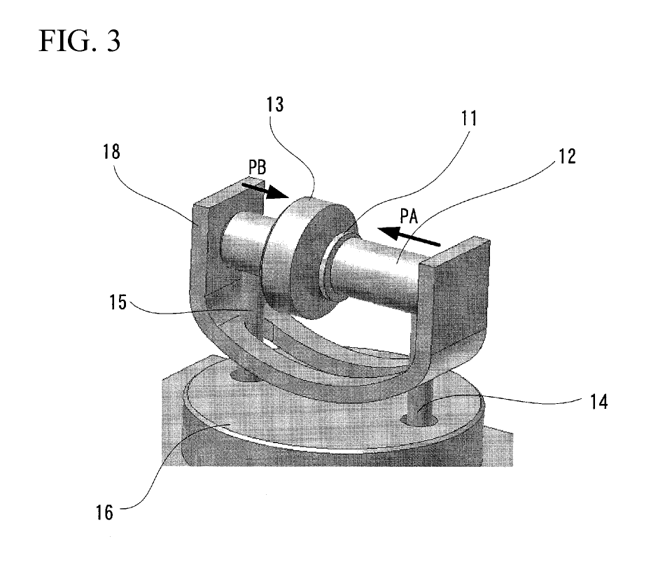

While in the example described above the sensor chip 11 was held under pressure between the duct members 12 and 13 through the use of elastic connecting ducts 14 and 15, instead, as illustrated in FIG. 2, ring-shaped leaf springs 17 may be provided lying on the outsides of the first duct member 12 and the second duct member 13, which are sandwiched therebetween. Moreover, as illustrated in FIG. 3, a U-shaped leaf spring 18 may be provided lying on the outsides of the first duct member 12 and the second duct member 13, which are sandwiched therein. In these cases there is no need for the connecting ducts 14 and 15 to be elastic, but rather it is the leaf springs 17 and 18 that function as the elastic holding member in the present invention.

As illustrated in FIG. 1, when the elastic holding member is structured from the elastic connecting ducts 14 and 15, they can also serve as the guiding ducts (ducts wherein a pressure transmitting medium is sealed) for guiding the measurement pressure to the sensor chip 11, making it possible to reduce parts counts, reduce size, and achieve cost reductions. Moreover, the outer diameter within the ducts can be adjusted for the connecting ducts 14 and 15, enabling a design with any arbitrary elastic force PA or PB, making it possible to handle easily the high-pressure and high-differential-pressure applications for which there has been growing demand over recent years.

Furthermore, while in the example set forth above the structure of the sensor chip 11 is a five-layer structure wherein the sensor diaphragm 11-1 and stopper members 11-2 and 11-3 are bonded to pedestals 11-4 and 11-5, the structure need not necessarily be one with bonded pedestals 11-4 and 11-5, but rather may be a three-layer structure of the sensor diaphragm 11-1 and the stopper members 11-2 and 11-3.

Note that while in the example set forth above the sensor diaphragm 11-1 was of a type wherein a strain resistance gauge was formed wherein the resistance value changes in response to a change in pressure, the sensor chip may instead be of an electrostatic capacitance type. A sensor chip of an electrostatic capacitance type is provided with a substrate that is provided with a specific space (a capacitance chamber), a diaphragm that is provided over the space in the substrate, a stationary electrode that is formed on the substrate, and a movable electrode that is formed on the diaphragm. When the diaphragm bears pressure and is deformed, the spacing between the movable electrode and the stationary electrode changes, changing the electrostatic capacitance therebetween.

### Extended Forms of Example

While the present invention has been explained above in reference to the form of example, the present invention is not limited to the form of example set forth above. The structures and details in the present invention may be varied in a variety of ways, as can be understood by one skilled in the art, within the scope of technology in the present invention.

1. A differential sensor comprising:
a sensor chip having
a sensor diaphragm that outputs a signal in accordance with a differential pressure,
a first stopper member provided to the sensor diaphragm with a recessed portion of the first stopper member facing a first face of the sensor diaphragm, the first stopper member stopping excessive dislocation when an excessively large pressure is applied to a second face of the sensor diaphragm, and
a second stopper member provided to the sensor diaphragm with a recessed portion of the second stopper member facing the second face of the sensor diaphragm, the second stopper member stopping excessive dislocation when an excessively large pressure is applied to the first face of the sensor diaphragm;
a first duct member provided to a first face of the sensor chip, having, therein, a pressure guiding duct that guides a measurement pressure to the first face of the sensor diaphragm;
a second duct member, provided to a second face of the sensor chip, having, therein, a pressure guiding duct that guides a measurement pressure to the second face of the sensor diaphragm; and
an elastic holding member that applies an elastic force to the first duct member in the direction of the first face of the sensor chip, applies an elastic force to the second duct member in the direction of the second face of the sensor chip, and holds the sensor chip under pressure between the first duct member and the second duct member.

2. The differential pressure sensor as set forth in claim 1, wherein the elastic holding member is structured from an elastic first connecting duct that connects to the pressure guiding duct of the first duct member and an elastic second connecting duct that connects to the pressure guiding duct of the second duct member.

3. The differential pressure sensor as set forth in claim 1, wherein
the elastic holding member is a leaf spring that lies on an outside of the first duct member and the second duct member, which are sandwiched therebetween.

4. The differential pressure sensor as set forth in claim 1, wherein
the sensor chip has
a first pedestal provide to the first stopper member, and
a second pedestal provided to the second stopper member.
